(19) United States
(12) Patent Application Publication
(10) Pub. No.: US 2026/0100110 A1
(43) Pub. Date: Apr. 9, 2026

(54) SELF-CONTAINED PROJECTILE DROPPING GAME

(71) Applicant: TOUCHMAGIX MEDIA PVT. LTD., Pune (IN)

(72) Inventor: Anup Tapadia, Pune (IN)

(73) Assignee: TOUCHMAGIX MEDIA PVT. LTD., Pune, MH (IN)

(21) Appl. No.: 18/909,106

(22) Filed: Oct. 8, 2024

(51) Int. Cl. G07F 17/32

(52) U.S. Cl. CPC G07F 17/3295; G07F 17/323; G07F 17/3237; G07F 17/3262; G07F 17/3297; G07F 17/3246; G07F 17/3248; G07F 17/3253

(57) ABSTRACT

A system comprising a gaming unit is described. The gaming unit comprises a drop device, a controller, and an array of sensors. The controller is operable to receive a first command to maneuver the drop device seamlessly and simultaneously in at least one of a first direction, a second direction, and a third direction and position the drop device over one or more targets in a playing field; and receive a second command to release one or more projectiles towards the one or more targets. The array of sensors determines a contact location of the one or more projectiles on the playing field. The computing unit is operable to determine an output of the game based on a third command received from the array of sensors. The drop device can dynamically move and align with respect to each target in the playing field upon receiving the first command.

### FIELD OF THE INVENTION

This disclosure relates generally to a gaming system and, more particularly, to a self-contained projectile dropping game.

### BACKGROUND

“An amusement device is disclosed having a housing for enclosing a playing field, and at least one target disposed on the playing field, the target oriented for interaction with a vertically dropped projectile. The device further includes a pick-up device within the housing, the pick-up device suspended from a rail arrangement that provides for four-way horizontal movement over the playing field. The device has player controls including a first control for maneuvering the pick-up device in a horizontal plane above the playing field, and a second control for releasing the projectile, wherein an objective of the amusement device is to position the pick-up device over a target and release the projectile to hit the target to win the prize.” [Source: U.S. Pat. No. 8,678,395B2, titled Ball drop game; Shoemaker]

“An amusement device that includes a horizontally oriented rotating wheel having a plurality of apertures through the wheel and a release mechanism that will release game pieces from a location above the wheel is disclosed. The game can be played by exercising skill or it can be configured to result in a random outcome. In the skilled based embodiment of the invention, a user tries to time the activation of the release mechanism so that a high energy ball drops down from the release mechanism and falls through the rotating wheel. If a ball passes directly through the wheel, the ball is detected by a detector that is positioned below the wheel and an award is provided to the player. In an alternative embodiment of the device, the device is designed to release a plurality of balls which will bounce and roll on the rotating wheel until they are captured in apertures that are provided through the wheel. Each aperture has a detector and if the balls are captured in pre-selected apertures, an award is provided to the player.”

Therefore, there is a long-felt need for a self-contained gaming system that enables the user to utilize his/her skill to position (move, aim and align) a movable drop device as well as release one or more projectiles at an appropriate time to achieve one or more targets.

### SUMMARY OF INVENTION

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

Disclosed herein are a system, a method, and a non-transitory computer readable storage medium of a gaming unit.

In one aspect, a system is described. The system comprises a gaming unit that provides a game to a user. The gaming unit comprises a drop device, a computing unit, a controller, and an array of sensors. The drop device holds one or more projectiles. The computing unit comprises a game logic. The controller is electronically coupled to the computing unit. The controller is operable to receive a first command to maneuver the drop device seamlessly and simultaneously in at least one of a first direction, a second direction, and a third direction and position the drop device over one or more targets in a playing field; and receive a second command to release the one or more projectiles towards the one or more targets in the playing field. The array of sensors that determines a contact location of the one or more projectiles on the playing field. The computing unit is further operable to determine an output of the game based on a third command received from the array of sensors. In an embodiment, the drop device is configured to dynamically move and align with respect to each target of the one or more targets in the playing field upon receiving the first command. The playing field comprises the one or more targets.

In an embodiment, the game comprises a self-contained ball dropping game.

In another embodiment, the computing unit comprises an artificial intelligence engine.

In another embodiment, the computing unit monitors the output of the game and assigns a point based on the output of the game.

In another embodiment, the one or more targets comprises a plurality of first targets, a plurality of second targets and a plurality of third targets.

In another embodiment, the plurality of first targets, the plurality of second targets, and the plurality of third targets are distributed and located randomly within the playing field.

In another embodiment, the plurality of first targets, the plurality of second targets, and the plurality of third targets are distributed and located in an ordered fashion within the playing field.

In yet another embodiment, the computing unit determines whether the one or more projectiles repeatedly is released towards at least one of the plurality of first targets, the plurality of second targets, and the plurality of third targets.

In yet another embodiment, the computing unit is operable to assign a first point when the controller determines whether the one or more projectiles is repeatedly released towards at least one of the plurality of first targets, the plurality of second targets, and the plurality of third targets.

In yet another embodiment, the computing unit determines whether the one or more projectiles makes contact with one or more predefined targets among the one or more targets.

In yet another embodiment, the computing unit is operable to assign a second point when the controller determines whether the one or more projectiles makes contact with the one or more predefined targets.

In yet another embodiment, the one or more predefined targets is pointed out by an indicator in the playing field.

In yet another embodiment, the computing unit is communicatively coupled to a display.

In yet another embodiment, the display comprises at least one of light-emitting diode (LED) display, a liquid-crystal display (LCD) display, an organic light-emitting diode (OLED), a transparent display, a hologram, a projector, an augmented reality display, a virtual reality display, a mixed reality display, a split screen display, a multi-segment display, and a plasma display.

In yet another embodiment, the display comprises an interactive display.

In yet another embodiment, the display is operable to display at least one of a point, and at least one of a suggestion, a recommendation, an instruction, and a hint for winning the game.

In yet another embodiment, the computing unit, comprising an artificial intelligence engine analyzes an execution of the game by the gaming unit in response to a user input and communicates at least one of a point, and a suggestion, a recommendation, an instruction, and a hint for winning the game to the display.

In yet another embodiment, the display depicts at least one of the points won by the user, a level achieved, a reward and a current status of the game based on a sixth command received from the controller.

In yet another embodiment, the hint for winning the game depicts a location for the drop device to be maneuvered and to release the one or more projectiles to make contact with the target.

In yet another embodiment, the first direction is perpendicular to the second direction in a plane.

In yet another embodiment, the first direction represents x-axis, the second direction represents y-axis, and the third direction represents z-axis.

In yet another embodiment, the first direction in a first plane is perpendicular to the second direction in a second plane.

In yet another embodiment, the array of sensors comprises one of an array of infrared proximity sensors, an array of light detection and ranging (LIDAR) sensors, an array of mechanical switches, an array of tomographic sensors, an array of microwave motion sensors, an array of passive infrared (PIR) sensors, an array of capacitive sensors, an array of line cut sensors, and an array of ultrasonic sensors.

In yet another embodiment, the playing field comprises an array of indicators.

In yet another embodiment, a first indicator of the array of indicators located in a proximity range to a first sensor of the array of sensors, and a second indicator of the array of indicators located in the proximity range to a second sensor of the array of sensors.

In yet another embodiment, the first indicator of the array of indicator communicatively coupled to the first sensor of the array of sensors, and the second indicator of the array of indicator communicatively coupled to the second sensor of the array of sensors.

In yet another embodiment, the first sensor communicates instructions to the first indicator to provide an indication upon detecting that the contact location of the one or more projectiles coincides with the one or more targets.

In yet another embodiment, the gaming unit providing the game further comprises: a projectile collection unit that comprises a structure that covers bottom of the playing field and collects the one or more projectiles from the bottom of the playing field; a projectile conveyor unit that picks up and transports the one or more projectiles from the projectile collection unit to the drop device; and a projectile loading unit that loads the one or more projectiles from the projectile conveyor unit to the drop device.

In yet another embodiment, the computing unit is operable to assign a first point when the computing unit determines that the one or more projectiles makes contact with the one or more targets in the playing field.

In yet another embodiment, the computing unit is operable to assign a second point when the computing unit determines that the one or more projectiles makes contact with a different target in the playing field.

In yet another embodiment, the computing unit is further operable to depict, via a display, at least one of points won by the user, one or more levels achieved, one or more rewards and a current status of the game.

In yet another embodiment, the computing unit is operable to credit one or more playing chances to the user when the one or more projectiles is released towards the one or more targets in the playing field, wherein the one or more playing chances enables the user to play the game.

In yet another embodiment, the computing unit is operable to credit the one or more playing chances to a user account by one of physically to a prepaid card and remotely to an online account.

In yet another embodiment, the computing unit is further operable to provide the one or more rewards to the user.

In yet another embodiment, the one or more rewards provide an extra play to the game via the gaming unit.

In yet another embodiment, the drop device comprises a laser gun that releases one or more laser beams as the one or more projectiles.

In yet another embodiment, the controller and the computing unit are integrated.

In yet another embodiment, the controller receives the first command to maneuver the drop device from an input device.

In yet another embodiment, the controller receives the second command to release the one or more projectiles to make contact with the one or more targets in the playing field from an input device.

In yet another embodiment, the input device comprises at least one of a joystick, a button, an arrow key, a touch screen, a user interface, a graphic tablet, a light pen, a track ball, a mouse, a gamepad, a pointing device, a scanner, a token receiver, and a stylus.

In yet another embodiment, a token to enable the gaming unit for the user is scanned through the scanner.

In yet another embodiment, the system receives a token physically through the token receiver.

In yet another embodiment, the drop device comprises one or more of a claw, a shooting machine, a triggering machine, a chute, a scooper, an electromagnetic operated stopper, a mechanical operated stopper, a pneumatic operated stopper, a vacuum operated stopper, and a hydraulic operated stopper.

In yet another embodiment, the system comprises a dispenser that comprises a housing containing one or more rewards, a dispenser controller, and a reward dispenser; wherein the dispenser controller is configured to receive information regarding the one or more rewards associated with the user and to cause the reward dispenser to dispense the one or more rewards.

In yet another embodiment, the reward dispenser dispenses at least one of one or more gifts, the one or more rewards, one or more tokens, cash, one or more coins, and one or more tickets to the user based on the output of the game.

In yet another embodiment, the artificial intelligence engine is configured to analyze a behavior of the user based on one or more user inputs; analyze a previous execution of the game in response to the one or more user inputs; and generate at least one of a suggestion, a recommendation, and a hint based on at least one of the analysis of the behavior of the user and the analysis of the previous execution of the game.

In yet another embodiment, the artificial intelligence engine analyzes the behavior of the user by analyzing a pattern of the one or more user inputs.

In yet another embodiment, the gaming unit further comprises a gantry that supports the drop device.

In yet another embodiment, the gaming unit further comprises: a control signal reception unit that receives at least one of a first virtual control signal and a second virtual control signal from a remote environment.

In yet another embodiment, the remote environment comprises one of an augmented reality environment, a virtual reality environment and a mixed reality environment.

In yet another embodiment, the remote environment generates a virtual model of the gaming unit.

In yet another embodiment, the virtual model comprises a virtual representation of the gaming unit and a virtual user interface object at a respective location in the virtual representation of the gaming unit.

In yet another embodiment, the virtual model comprises a virtual three-dimensional model.

In yet another embodiment, the virtual model receives an input through at least one of the virtual representation of the gaming unit and the virtual user interface object in the virtual representation.

In yet another embodiment, the virtual model communicates at least one of the first virtual control signal and the second virtual control signal to the control signal reception unit in response to the input.

In yet another embodiment, the controller is further configured to receive a fourth command to maneuver the drop device seamlessly and simultaneously in at least one of the first direction, the second direction, and the third direction and position the drop device over the one or more targets in response to the first virtual control signal; and receive a fifth command to release the one or more projectiles towards the one or more targets in the playing field in response to the second virtual control signal.

In yet another embodiment, the system comprises a remote control.

In yet another embodiment, the game comprises a game of skill.

In yet another embodiment, the gaming unit comprises a plurality of gaming cabinets synchronized with each other towards an objective.

In yet another embodiment, the system enables a plurality of users to play the game through the plurality of gaming cabinets.

In yet another embodiment, the system comprises a card reader that reads an identity card associated with the user and verifies an identity of the user.

In yet another embodiment, the card reader comprises a slot and a read head, wherein the read head reads information associated with the identity card of the user when the identity card is swiped through the slot.

In yet another embodiment, the computing unit, using the artificial intelligence engine, is configured to convert the point won by the user to one or more gifts, one or more rewards, one or more tokens, one or more tickets, and one or more playing chances to the user based on the output of the game.

In yet another embodiment, the artificial intelligence engine learns continuously from a play of the user, and a behavior of the user to generate one or more recommendations, one or more hints, and one or more suggestions to enhance gaming experience.

In yet another embodiment, the artificial intelligence engine improves the play in future by learning from the play of the user, and the behavior of the user.

In yet another embodiment, the one or more suggestions provide indications at one or more locations to which the drop device to be maneuvered and to release the one or more projectiles.

In yet another embodiment, the computing unit comprises a software application.

In yet another embodiment, the software application comprises a stand-alone application.

In yet another embodiment, the software application comprises a client-server application.

In yet another embodiment, the computing unit is configured to credit a point based on the output of the game.

In yet another embodiment, the computing unit communicates instructions to a dispenser to dispense at least one of one or more gifts, one or more rewards, one or more tokens, cash, one or more coins, and one or more tickets to the user based on the output of the game.

In yet another embodiment, the playing field comprises one of a static playing field and a movable playing field.

In yet another embodiment, the playing field is rotatable on its own axis.

In yet another embodiment, the playing field is revolving around an object.

In yet another embodiment, the playing field is moving one of laterally and longitudinally.

In yet another embodiment, the projectile loading unit comprises a flexible conduit that loads the one or more projectiles from the projectile conveyor unit to the drop device.

In yet another embodiment, the flexible conduit moves flexibly along with the drop device when the drop device is maneuvered.

In yet another embodiment, the flexible conduit loads the one or more projectiles from the projectile conveyor unit to the drop device while the drop device is maneuvered to align with the one or more targets.

In yet another embodiment, the drop device is operable to release seamlessly and simultaneously a plurality of projectiles among the one or more projectiles.

In another aspect, a method is described. The method comprises: receiving a first command, by a controller, to maneuver a drop device seamlessly and simultaneously in at least one of a first direction, a second direction, and a third direction and position the drop device over one or more targets in a playing field; receiving a second command, by the controller, to release one or more projectiles towards the one or more targets in the playing field; and determining, by a computing unit, an output of a game based on a third command received from an array of sensors. The drop device is configured to dynamically move and align with respect to each target of the one or more targets in the playing field upon receiving the first command. The playing field comprises the one or more targets.

In one embodiment, the method further comprises: determining whether the one or more projectiles repeatedly is released towards at least one of a plurality of first targets, a plurality of second targets, and a plurality of third targets.

In one embodiment, the method further comprises: assigning a first point when the controller determines whether the one or more projectiles is repeatedly released towards at least one of the plurality of first targets, the plurality of second targets, and the plurality of third targets.

In one embodiment, the method further comprises: determining whether the one or more projectiles makes contact with one or more predefined targets among the one or more targets.

In one embodiment, the method further comprises: assigning a second point when the controller determines whether the one or more projectiles makes contact with the one or more predefined targets.

In one embodiment, the method further comprises: assigning a first point when the computing unit determines that the one or more projectiles makes contact with the one or more targets in the playing field.

In one embodiment, the method further comprises: assigning a second point when the computing unit determines that the one or more projectiles makes contact with a different target in the playing field.

In one embodiment, the method further comprises: depicting, via a display, at least one of points won by a user, one or more levels achieved, one or more rewards and a current status of the game.

In one embodiment, the method further comprises: crediting one or more playing chances to the user when the one or more projectiles contacts the one or more targets in the playing field, wherein the one or more playing chances enables the user to play the game.

In one embodiment, the method further comprises: crediting the one or more playing chances to a user account by one of physically to a prepaid card and remotely to an online account.

In one embodiment, the method further comprises: providing the one or more rewards to the user.

In one embodiment, the method further comprises: receiving the first command to maneuver the drop device from an input device.

In one embodiment, the method further comprises: receiving the second command to release the one or more projectiles to make contact with the one or more targets in the playing field from an input device.

In one embodiment, the method further comprises: analyzing a behavior of a user based on one or more user inputs; analyzing a previous execution of the game in response to the one or more user inputs; and generating at least one of a suggestion, a recommendation, and a hint based on at least one of the analysis of the behavior of the user and the analysis of the previous execution of the game.

In one embodiment, the method further comprises: analyzing the behavior of the user by analyzing a pattern of the one or more user inputs.

In one embodiment, the method further comprises:
receiving at least one of a first virtual control signal and a second virtual control signal from a remote environment.

In one embodiment, the method further comprises: generating a virtual model of a gaming unit.

In one embodiment, the virtual model comprises a virtual representation of the gaming unit and a virtual user interface object at a respective location in the virtual representation of the gaming unit.

In one embodiment, the method further comprises: receiving an input, by the virtual model, through at least one of the virtual representation of the gaming unit and the virtual user interface object in the virtual representation.

In one embodiment, the method further comprises: communicating by the virtual model at least one of the first virtual control signal and the second virtual control signal to a control signal reception unit in response to the input.

In one embodiment, the method further comprises: receiving a fourth command to maneuver the drop device seamlessly and simultaneously in at least one of the first direction, the second direction, and the third direction and position the drop device over the one or more targets in response to the first virtual control signal; and receiving a fifth command to release the one or more projectiles towards the one or more targets in the playing field in response to the second virtual control signal.

In another aspect, a non-transitory computer readable storage medium is described. The non-transitory computer readable storage medium storing a sequence of instructions, which when executed by a processor, causes: receiving a first command, by a controller, to maneuver a drop device seamlessly and simultaneously in at least one of a first direction, a second direction, and a third direction and position the drop device over one or more targets in a playing field; receiving a second command, by the controller, to release one or more projectiles towards the one or more targets in the playing field; and determining, by a computing unit, an output of a game based on a third command received from an array of sensors. In an embodiment, the drop device is configured to dynamically move and align with respect to each target of the one or more targets in the playing field upon receiving the first command. In another embodiment, the playing field comprises the one or more targets.

In one embodiment, the non-transitory computer readable storage medium further causes: determining whether the one or more projectiles repeatedly is released towards at least one of a plurality of first targets, a plurality of second targets, and a plurality of third targets.

In one embodiment, the non-transitory computer readable storage medium further causes: assigning a first point when a controller determines whether the one or more projectiles is repeatedly released towards at least one of the plurality of first targets, the plurality of second targets, and the plurality of third targets.

In one embodiment, the non-transitory computer readable storage medium further causes: determining whether the one or more projectiles makes contact with one or more predefined targets among the one or more targets.

In one embodiment, the non-transitory computer readable storage medium further causes: assigning a second point when a controller determines whether the one or more projectiles makes contact with the one or more predefined targets.

In one embodiment, the non-transitory computer readable storage medium further causes: assigning a first point when a computing unit determines that the one or more projectiles makes contact with the one or more targets in the playing field.

In one embodiment, the non-transitory computer readable storage medium further causes: assigning a second point when a computing unit determines that the one or more projectiles makes contact with a different target in the playing field.

In one embodiment, the non-transitory computer readable storage medium further causes: depicting, via a display, at least one of points won by a user, one or more levels achieved, one or more rewards and a current status of the game.

In one embodiment, the non-transitory computer readable storage medium further causes: crediting one or more playing chances to the user when the one or more projectiles contacts the one or more targets in the playing field, wherein the one or more playing chances enables the user to play the game.

In one embodiment, the non-transitory computer readable storage medium further causes: crediting the one or more playing chances to a user account by one of physically to a prepaid card and remotely to an online account.

In one embodiment, the non-transitory computer readable storage medium further causes: providing the one or more rewards to the user.

In one embodiment, the non-transitory computer readable storage medium further causes: receiving the first command to maneuver the drop device from an input device.

In one embodiment, the non-transitory computer readable storage medium further causes: receiving the second command to release the one or more projectiles to make contact with the one or more targets in the playing field from an input device.

In one embodiment, the non-transitory computer readable storage medium further causes: analyzing a behavior of a user based on one or more user inputs; analyzing a previous execution of the game in response to the one or more user inputs; and generating at least one of a suggestion, a recommendation, and a hint based on at least one of the analysis of the behavior of the user and the analysis of the previous execution of the game.

In one embodiment, the non-transitory computer readable storage medium further causes: analyzing the behavior of the user by analyzing a pattern of the one or more user inputs.

In one embodiment, the non-transitory computer readable storage medium further causes: receiving at least one of a first virtual control signal and a second virtual control signal from a remote environment.

In one embodiment, the non-transitory computer readable storage medium further causes: generating a virtual model of a gaming unit.

In one embodiment, the virtual model comprises a virtual representation of the gaming unit and a virtual user interface object at a respective location in the virtual representation of the gaming unit.

In one embodiment, the non-transitory computer readable storage medium further causes: receiving an input, by the virtual model, through at least one of the virtual representation of the gaming unit and the virtual user interface object in the virtual representation.

In one embodiment, the non-transitory computer readable storage medium further causes: communicating by the virtual model at least one of the first virtual control signal and the second virtual control signal to a control signal reception unit in response to the input.

In one embodiment, the non-transitory computer readable storage medium further causes: receiving a fourth command to maneuver the drop device seamlessly and simultaneously in at least one of the first direction, the second direction, and the third direction and position the drop device over the one or more targets in response to the first virtual control signal; and receiving a fifth command to release the one or more projectiles towards the one or more targets in the playing field in response to the second virtual control signal.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE DRAWINGS

These and other aspects of the present disclosure will now be described in more detail, with reference to the appended drawings showing exemplary embodiments, in which:

FIG. 1 illustrates a block diagram of a gaming unit, according to one or more embodiments.

FIG. 2 illustrates a schematic view of a gaming unit, according to one or more embodiments.

FIG. 3 illustrates the mobility of a drop device of a gaming unit, according to one or more embodiments.

FIG. 4A and FIG. 4B illustrate the mobility of a drop device in the same plane, according to one or more embodiments.

FIG. 5 illustrates the mobility of a drop device in two different planes, according to one or more embodiments.

FIG. 6 illustrates a block diagram of a gaming unit operated from a virtual reality environment, according to one or more embodiments.

FIG. 7 illustrates the mobility of a drop device, according to one or more embodiments.

FIG. 8 illustrates a method of executing a game by a gaming unit, according to one or more embodiments.

FIG. 9A shows a structure of the neural network/machine learning model with a feedback loop.

FIG. 9B shows a structure of the neural network/machine learning model with reinforcement learning.

FIG. 10A shows a block diagram of the cyber security module in view of the system and server.

FIG. 10B shows an embodiment of the cyber security module.

FIG. 10C shows another embodiment of the cyber security module.

FIG. 11 illustrates a block diagram of a system, according to one or more embodiments.

FIG. 12 illustrates a block diagram of a gaming unit, according to one or more embodiments.

FIG. 13 illustrates an array of sensors, according to one or more embodiments.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

In order to fully understand the scope of the invention, the following terms used herein are hereby defined.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

The term “comprising,” which is synonymous with “including,” “containing,” or “characterized by” here is defined as being inclusive or open-ended, and does not exclude additional, unrecited elements or method steps, unless the context clearly requires otherwise.

The term “media” is defined as forms of electronically transmitted information, such as audio, video, graphics, and/or text.

The term “device” is defined as an electronic element that cannot be divided without destroying its stated function.

The term “user” includes a person. The term “user” may also refer to a person who is playing a game or using the gaming system.

The term “communicatively coupled” is defined as devices connected in a way that permits communication.

The term “configured” is defined as arranged within the system to perform certain functions.

The term “receiving” is defined as being given information.

The term “response” is defined as something constituting a reply or a reaction.

The term “based on” is defined as dependent on.

The term “a plurality of” is defined as multiple.

The term “memory” is defined as any device in which information can be stored.

The term “execute” is defined as run or launch.

The term “instructions” is defined as software program or machine executable code.

The term “trigger” is defined as an event, message, or message sequence sufficient to initiate, cause, or task an action.

The term “component” is intended to be broadly construed as hardware, firmware, and/or a combination of hardware and software.

The term “game” refers to an activity that one engages in for amusement, or fun or reward, a game which involves interaction of a user. The game may involve social and interpersonal skills. The game may also involve a physical gadget for the user to interact with and play the game.

The term “stand-alone game” refers to a game that is not dependent and can be played independently. The “stand-alone game” also refers to a game that is played without connecting to the internet. The “stand-alone game” is also one that is not dependent on being online in order to play the game. The “stand-alone game” is complete in itself and self-contained. The stand-alone game can be played either online or offline.

The term “drop device” refers to an apparatus for holding and releasing a projectile. The “drop device” can be seamlessly and simultaneously maneuvered in x direction, y direction, and z direction to an exact location over one or more targets. The “drop device” can also be seamlessly and simultaneously maneuvered in both vertical and horizontal directions. A gantry may support the drop device. The drop device can be one of a mechanical operated device, a vacuum operated device, a hydraulic operated device, a pneumatic operated device, etc. The drop device may also be an illumination source for directing the light towards the target. The drop device may also be one of a signal generator that generates a signal (e.g., a laser, electromagnetic wave, etc.) and aims towards the target. In an embodiment, the drop device releases (e.g., shooting, dropping, ejecting, transmitting, etc.) the one or more projectiles directly towards the one or more targets. In another embodiment, the drop device releases the one or more projectiles indirectly towards the one or more targets (e.g., makes contact with the other surface and redirects it towards the one or more targets).

The term “projectile” refers to an object that can be of any form, any material, any shape, and any size that makes contact with one or more targets. The projectile may be one of such as a plate, a disc, a ball, a ring, a toy, a coin, an object, etc. The projectile may be picked, held, and released by a drop device. In one embodiment, the term “projectile” may refer to at least one of a signal, an illumination, a laser beam, a radiation, a wave, etc. released from the device aiming towards the target. The projectile may be released directly towards the one or more targets by the drop device.

The term “contact location” as used herein refers to a location on which the one or more projectiles make contact with the playing field. The one or more projectiles may be aimed to maneuver over the one or more targets on the playing. The one or more projectiles may be then released to make contact with the one or more targets. The one or more projectiles may contact the one or more targets. In some cases, the one or more projectiles may not contact the one or more targets and may make contact with the playing field. The location on which the one or more projectiles make contact with the playing field refers to the contact location.

The term “contact with the target” as used herein refers to one or more of hitting one or more targets, passing through one or more targets, sticking onto the one or more targets, spreading over the one or more targets, converge towards the one or more targets, diverge towards the one or more targets, virtual contact with the one or more targets, physical contact with the one or more targets. The virtual contact with the one or more targets refers to one or more signals falling on the one or more targets (e.g., a laser beam falling on the one or more targets).

The term “self-contained game” as used herein refers to a game that has everything necessary to be independent or to work independently. The self-contained game refers to a game that is complete in itself for the execution of the game. The self-contained game refers to a game that is complete and separate that does not need help or resources from outside. The self-contained game comprises an anti-jamming mechanism that does not require any external source or help to reboot, restart, and reset the game.

The term “playing field” refers to a field or an environment where a user may interact to perform an activity or play a game. The user upon interacting with the playing field may experience fun, entertainment, etc. The playing field may be a skill-based playing field, or a non-skill based playing field. The playing field may be a static playing field. The playing field may be a dynamic playing field. The playing field may comprise one or more targets. The one or more targets comprise a plurality of first targets, a plurality of second targets, and plurality of third targets arranged in ordered fashion or random fashion. In an embodiment, the one or more targets in the static playing field are static. In another embodiment, the one or more targets in the static playing field are dynamic. In another embodiment, the one or more targets in the dynamic playing field are dynamic. In another embodiment, the one or more targets in the dynamic playing field are static. The playing field further comprises a plurality of sensors positioned in proximity to the plurality of targets, respectively. The playing field further comprises a plurality of indicators positioned in proximity to the plurality of targets, respectively. The user may utilize his/her skill to position the drop device to release the projectile towards the target when the playing field is static. The user may utilize his/her skill to both position the drop device as well as to release the projectile at an appropriate time towards the target when the playing field is dynamic. As the playing field and the drop device are dynamic (e.g., movable), the user may need extraordinary skill to win the game which enhances the gaming experience for the user.

The term “gaming unit” refers to a device or an environment where the user may interact and play a game. The user's interaction may provide gaming experience. The user's activity may be skill based or non-skill based activity. The gaming unit may be a physical gaming unit. The user may also interact with the gaming unit virtually or digitally through a remote environment. The gaming unit may also enable the user to play a game with assistance from a computer or other electronic device (e.g., input device).

The term “game logic” refers to a programming logic applied to a game. The game logic may refer to an internal mechanism of a game in order to perform all the tasks needed for execution of the game.

As used herein the term “game of chance” refers to a game when the outcome of the game is predominantly determined by chance. A “game of chance” is determined mainly by a random factor of any type. In games of chance, the usage of skill is present, but a higher level of chance determines success. Games like playing cards, roulette, rolling a dice, or even picking a numbered ball are reflected upon as chance-based games. It is pertinent to note that players here do not have control over the outcome of the result.

As used herein the term “game of skill” refers to a game when the outcome of the game is predominantly determined by skill. The game of skill is also referred to as a skill based game. A “game of skill” is based mainly on the mental or physical level of expertise of a player, rather than a chance. One of the most significant benefits of a game of skill is that it provides freedom to the players to explore their capabilities in the sport. These games invigorate the players to get accustomed to a certain set of rules while looking for ways to improve and implement different strategies through consistent practice. The game of skill may have a chance component to a certain extent. However, it is the individual skills that determine the success rate (i.e., the outcome).

As used herein, the term “claw” refers to the apparatus used to pick objects, move, and release them. The claw may have one or more fingers, prongs, or grippers to grab the object. The claw may also be a magnet which attracts the object. Claws may also be operated on by means of a pneumatic, hydraulic, and vacuum mechanism. Claws may also use other mechanisms to pick, move and release an object. The claw may be manipulated using a joystick or any other means. The claw is used in arcade claw crane games.

As used herein “Machine learning” refers to algorithms that give a computer the ability to learn without being explicitly programmed, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,”and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The term “processor” is defined as a component in the server for executing instructions stored in memory.

As used herein, two or more elements or modules are “integral” or “integrated” if they operate functionally together. Two or more elements are “non-integral” if each element can operate functionally independently. In an embodiment, the controller and the computing unit are integrated into a single unit.

The term “transceivers” is defined as a component used for both transmission and reception of digital data.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices.

As used herein, the term “component” broadly construes hardware, firmware, and/or a combination of hardware, firmware, and software.

Other specific forms may embody the present disclosure without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple co-ordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a track ball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments may comprise or utilize a special purpose or general purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

Example embodiments, as described below, may be used to provide integrated primary gaming and secondary gaming systems. It will be appreciated that the various embodiments discussed herein need not necessarily belong to the same group of embodiments and may be grouped into various other embodiments not explicitly disclosed herein. In the following description, for purposes of explanation, numerous specific details are set forth in order to provide a thorough understanding of the various embodiments.

The foregoing disclosure provides illustration and description but is not intended to be exhaustive or to limit the implementations to the precise form disclosed. Modifications and variations are possible in light of the above disclosure or may be acquired from practice of the implementations.

Business Problem: Businesses, especially in the entertainment and digital media sectors, may face declining customer engagement and retention rates. Consumers are constantly seeking new, immersive experiences, and traditional offerings may no longer capture their attention. Monetizing can be challenging due to high competition, piracy, and the reliance on ad revenue models that may not be sustainable.

Business Solution: Self-contained projectile dropping gaming unit aligns with consumer preferences for interactive entertainment, meeting the demand for immersive and interactive gaming experiences. This dedicated gaming unit allows one to control the hardware and software environment, optimizing it for high-performance gaming and unique experiences that are not feasible on other platforms. This gaming unit enhances the overall customer experience, providing a memorable and interactive way for customers to engage.

Technical Problem: Arcade games, like any complex electronic and mechanical systems, can face a variety of technical problems that impact their operation and player experience. These games often have simple, repetitive mechanics that can become monotonous over time. Players may lose interest if the game lacks variety in levels, objectives, or challenges. Projectile dropping games typically require basic skills such as timing and aim but may not challenge players to develop advanced strategies or skills. The lack of depth can result in players feeling that they are not improving or being sufficiently challenged, which can decrease motivation to continue playing. Balancing the difficulty in projectile dropping games can be tricky. Levels that are too easy can be boring, while overly difficult levels can frustrate players. Further, the conventional gaming unit does not provide assistance or hints to succeed in the tasks. Further the projectiles in the conventional gaming units have to be loaded manually which interrupts and deviates the players interest in continuing the game. Accordingly, there remains a need for an automated gaming unit that enhances the player's gaming experience as well as providing assistance in improving the skills and succeeding in the tasks.

Technical Solution: Self-contained projectile dropping gaming unit provides sensors to track the outcomes of the gaming unit. The gaming unit further provides an artificial intelligence engine to analyze the behavior of the player and further provides suggestions/hints to enhance the gaming experience of the players. The gaming unit is automated such that it automatically reloads the projectile back within predefined time preserving the gaming interest of the player.

Technical Result: Self-contained projectile dropping game is an automated gaming unit that reloads the projectile by itself. Further the gaming unit monitors the gaming behavior of the players and provides hints or assistance in overcoming the tasks. The gaming unit further enhances the gaming experience of the player by providing scores and/or rewards.

How Technical Solution is a Technological Advancement: The technical solution enables providing automated gaming units. The technical solution provides enhanced gaming experience to the players as well as improving the gaming skills of the players. The technical solution further provides entertainment to the players while improving the skills of the players.

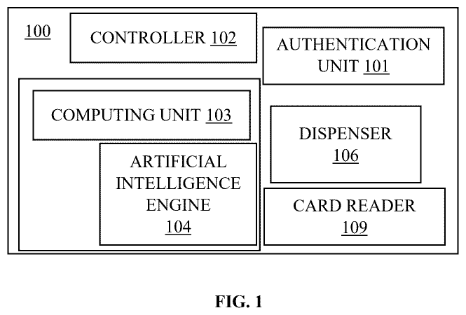

Technical Details Specific to the Technical Solution: FIG. 1 illustrates a block diagram of a gaming unit 100, according to one or more embodiments. The gaming unit 100 provides a game (e.g., self-contained projectile dropping game) to a user. The user may interact with the gaming unit 100 to execute the game. The game may be a physical game. The game may be a game of skill. The game may be a standalone game. The gaming unit 100 further comprises a controller 102 and a computing unit 103. The controller 102 is operable to receive a first command to maneuver the drop device seamlessly and simultaneously in at least one of a first direction, a second direction, and a third direction and position the drop device over one or more targets in a playing field. The controller 102 is operable to receive a second command to release the one or more projectiles towards the one or more targets in the playing field. The controller 102 may receive the first command and the second command from an input device. The user may interact with the input device and in turn the input device may communicate a command to the controller 102. The computing unit 103 comprises a game logic. The game logic comprises the information and procedures for execution of the game in a computer readable format (e.g., in a computer readable language). The game logic enables a processor residing within the computing unit to execute the game. In an embodiment, the controller 102 and the computing unit 103 are integrated into a single unit. In another embodiment, the controller 102 is operable to receive commands from a user via the input device and execute the game in accordance with the commands. The computing unit 103 is operable to co-ordinate the execution of the game in accordance with the game logic. The computing unit 103 comprises an artificial intelligence engine 104.

The artificial intelligence engine 104 may assist the user to play and win the game. The artificial intelligence engine 104 may provide recommendations, suggestions, or hints to the user to play the game and earn more rewards. In one embodiment, the artificial intelligence engine 104 is configured to analyze a behaviour of the user through one or more user inputs; analyze a previous execution of the game in response to the one or more user inputs; and generate at least one of a suggestion, a recommendation, and a hint based on the analysis of the behaviour of at least one of the user and the analysis of the previous execution of the game. The hint may comprise an indication of an appropriate location to which the drop device is to be maneuvered, and the projectile is to be released to contact the target to win high points/scores. The artificial intelligence engine 104 analyzes the behavior of the user by analyzing one or more patterns of the user inputs. The artificial intelligence engine 104 learns continuously from one or more plays of the user, and a behavior of the user to generate one or more recommendations, one or more hints, and one or more suggestions to enhance gaming experience. The one or more suggestions provide indications at one or more locations to which the drop device to be maneuvered and to release the projectile. The artificial intelligence engine 104 further improves the play in future by learning from the one or more plays of the user, and a behavior of the user.

In another embodiment, the gaming unit 100 enables multiple users to play the game towards a common objective. The gaming unit 100 provides a collaborative aspect and immersive experience to the users by enabling multiple users to play the games and achieve the common goal. In another embodiment, the gaming unit 100 enables synchronization of multiple primary gaming units and enables multiple users to play the game towards a common objective. In an embodiment, the gaming unit 100 comprises a dispenser 106 that comprises a housing containing a reward, a dispenser controller, and a reward dispenser. The dispenser controller is configured to receive information regarding the reward (e.g., scores/points, etc.) associated with the user and to cause the reward dispenser to dispense the reward. The reward dispenser dispenses at least one of a gift, a reward, a token, cash, a coin, and a ticket to the user based on the output of the game.

In one embodiment, the gaming unit 100 may comprise an authentication unit 101. The authentication unit 101 is configured to verify an identity of the user. The user may hold a card (e.g., Radio-Frequency Identification (RFID) card, etc.) that holds the identity information of the user. The authentication unit 101 reads the card associated with the user and verifies the identity of the user. The authentication unit 101 communicates activation signal to the gaming unit 100 upon verifying the identity of the user. The computing unit 103 upon receiving the activation signal activates the game in the gaming unit 100.

In one embodiment, the gaming unit 100 enables the user to interact and play the game from a remote place. The gaming unit 100 enables the user to operate the gaming unit and play the game from the remote place (which is useful during pandemics e.g., COVID). In an embodiment, the remote environment comprises one of an augmented reality environment, a virtual reality environment and a mixed reality environment. The remote environment comprises devices such as a remote control. The user may operate the remote control from the remote place and operate the gaming unit as similar to the user is physically present in front of the gaming unit.

In an embodiment, the gaming unit 100 comprises a card reader 109 that reads an identity card associated with the user and verifies an identity of the user. In an embodiment, the gaming unit 100 enables multiple users to play the game. The card reader 109 comprises a slot and a read head. The read head reads information associated with the identity card of the user when the identity card is swiped through the slot. In one embodiment, the gaming unit 100 validates a credential provided by the user and activates the game in the gaming unit 100. In an embodiment, the controller 102 comprises a software application. The software application comprises a stand-alone application. In an embodiment, the software application comprises a client-server application.

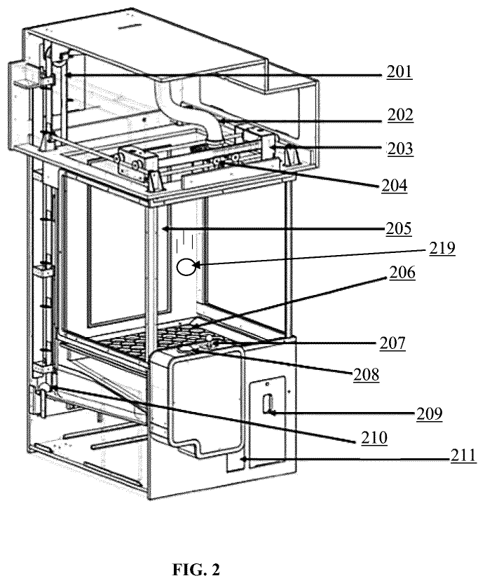

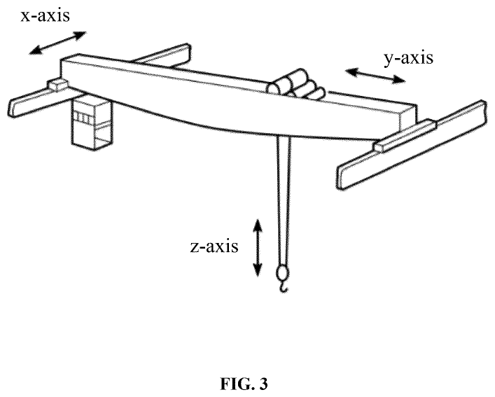

FIG. 2 illustrates a schematic view of a gaming unit, according to one or more embodiments. The gaming unit provides a game to a user. In an embodiment, the game comprises a self-contained projectile dropping game. The gaming unit comprises a projectile conveyor unit 201, a flexible pipe with projectile buffer 202, a gantry 203, a projectile drop mechanism 204, a monitor 205, a playfield with sensor array 206, a joystick 207, a button 208, and a projectile collection unit 210. The gaming unit further comprises a card reader 209, and a ticket dispenser 211. The gaming unit comprises a drop device, a controller, and a computing unit. The gantry 203 supports the drop device for mobility. The gantry 203 may be a moving gantry. The gantry can move seamlessly in at least one horizontal direction (e.g., x direction, y direction) and vertical direction. The gantry may operate the drop device in x-direction and y-direction seamlessly and simultaneously (as shown in FIG. 3). In an embodiment, the drop device comprises one or more of a claw, a shooting machine, a triggering machine, a chute, a scooper, an electromagnetic operated stopper, a mechanical operated stopper, a pneumatic operated stopper, a vacuum operated stopper, and a hydraulic operated stopper.

The drop device holds a projectile 219. The controller is adapted to receive a first command to maneuver the drop device seamlessly and simultaneously in at least one of a first direction, a second direction, and a third direction and position the drop device over a target of one or more targets in a playing field. In an embodiment, the controller receives the first command to maneuver the drop device from an input device. In an embodiment, the input device comprises at least one of a joystick, a button, an arrow key, a touch screen, a user interface, a graphic tablet, a light pen, a track ball, a mouse, a gamepad, a pointing device, a scanner, a token receiver, and a stylus. The drop device comprises one or more of a claw, a shooting machine, a triggering machine, a chute, a scooper, an electromagnetic operated stopper, a mechanical operated stopper, a pneumatic operated stopper, a vacuum operated stopper, and a hydraulic operated stopper. The drop device is configured to dynamically move and align with respect to each target of the one or more targets in the playing field upon receiving the first command. The controller may be further adapted to receive a second command to release the projectile towards the target in the playing field. The playing field comprises the one or more targets. In an embodiment, the playing field is a static playing field. In another embodiment, the playing field is dynamic playing field (i.e., movable playing field). In another embodiment, the one or more targets are static in the static playing field. In another embodiment, the one or more targets are dynamic in the static playing field. In another embodiment, the one or more targets are dynamic in the dynamic playing field. In another embodiment, the one or more targets are static in the dynamic playing field. In one embodiment, the movable playing field is rotatable on its own axis. In another embodiment, the movable playing field is revolving around an object. In another embodiment, the movable playing field is moving one of laterally and longitudinally. The gaming unit comprises a playfield with sensor array 206 that determines a contact location of the projectile 219 (e.g., target) on the playing field. The playfield with sensor array 206 may communicate a third command to the controller based on the contact location of the projectile 219. The computing unit is further operable to determine an output of the game based on a third command received from the array of sensors.

The computing unit monitors the output of the game and executes an additional play based on the output of the game. The computing unit is also configured to credit a point based on the output of the game. The one or more targets in the playing field comprises a plurality of first targets, a plurality of second targets and a plurality of third targets. The plurality of first targets, the plurality of second targets, and the plurality of third targets are distributed and located randomly within the playing field. In an embodiment, the plurality of first targets, the plurality of second targets, and the plurality of third targets are distributed and located in an ordered fashion within the playing field. The computing unit determines whether the projectile 219 repeatedly contacts at least one of the plurality of first targets, the plurality of second targets, and the plurality of third targets. In an embodiment, the computing unit is operable to assign a first point when the computing unit determines whether the projectile 219 repeatedly contacts at least one of the plurality of first targets, the plurality of second targets, and the plurality of third targets. The computing unit is further operable to determine whether the projectile 219 contacts a predefined target among the one or more targets. The computing unit is operable to assign a second point when the computing unit determines whether the projectile 219 contacts the predefined target. In an embodiment, the computing unit communicates instructions to a dispenser to dispense at least one of one or more gifts, one or more rewards, one or more tokens, cash, one or more coins, and one or more tickets to the user based on the output of the game. The computing unit comprises an artificial intelligence engine. The artificial intelligence engine, based on the analysis of the user behavior and the previous plays of the user, may point out a predefined target among the one or more targets in the playing field. The artificial intelligence engine may assign and depict a plurality of targets among the one or more targets as the one or more predefined targets by providing illumination with a different color through the plurality of indicators. The artificial intelligence engine communicates a signal to the playfield with sensor array 206 and the array of indicators to point out a predefined target among the one or more targets in the playing field. The predefined target is indicated by the indicator that is located in close proximity to the predefined target.

In an embodiment, the computing unit is communicatively coupled to a display. The display may depict the predefined target among the one or more targets by displaying the playing field onto a screen of the display. The display comprises a split screen having a first half displaying scores, points, etc. and a second half displaying suggestions, hints, recommendations, etc. In an embodiment, the display comprises at least one of light-emitting diode (LED) display, a liquid-crystal display (LCD) display, an organic light-emitting diode (OLED), a transparent display, a hologram, a projector, an augmented reality display, a virtual reality display, a mixed reality display, a split screen display, a multi-segment display, and a plasma display. In an embodiment, the multi-segment display comprises at least one of a three segment display, a seven-segment display, an eight segment display, a nine segment display, a ten segment display, an eleven segment display, a twelve segment display, a fourteen segment display, and a sixteen segment display. In an embodiment, the display comprises an interactive display. The display is further operable to display at least one of a point, and at least one of a suggestion, a recommendation, an instruction, and a hint for winning the game. In an embodiment, the computing unit, comprising an artificial intelligence engine analyzes the execution of the game by the gaming unit in response to a user input and communicates at least one of a point, and a suggestion, a recommendation, an instruction, and a hint for winning the game to the display. The display depicts at least one of the points won by the user, a level achieved, a reward and a current status of the game based on a sixth command received from the controller. The hint for winning the game depicts a location for the drop device to be maneuvered and to release the projectile to make contact with the target.

The drop device is seamlessly and simultaneously maneuvered in at least one of a first direction, a second direction, and a third direction and position the drop device over one or more targets in a playing field. The drop device is seamlessly and simultaneously maneuvered upon receiving the first command by the controller. In an embodiment, the first direction is perpendicular to the second direction in a plane. In another embodiment, the first direction represents x-axis, the second direction represents y-axis, and the third direction represents z-axis. In another embodiment, the first direction in a first plane is perpendicular to perpendicular to the second direction in a second plane. The user may maneuver the drop device seamlessly and simultaneously in at least one of the first direction, the second direction and the third direction using the input device (e.g., joystick 207). The controller is further adapted to release the projectile 219 towards the target in a playing field. The user may provide an input to release the projectile 219 using the button 208. Upon pressing the button 208, the drop device releases the projectile 219 to be dropped over the target on the playing field. The drop device releases the projectile 219 using the projectile drop mechanism 204. The input device comprises at least one of a joystick 207, the button 208, an arrow key, a touch screen, a user interface, a graphic tablet, a light pen, a track ball, a mouse, a gamepad, a pointing device, a scanner, a token receiver, and a stylus. The projectile drop mechanism 204 initially tightly holds the projectile 219 using its contacts. Later when the button 208 is pressed, the projectile drop mechanism 204 loosens its contacts with the projectile and releases the projectile 219. The projectile drop mechanism 204 functions like an electrically operated switch (e.g., relay). The user may need to utilize his/her skill to seamlessly maneuver and position the drop device over the target and release the projectile, at the appropriate time and location, towards the target. The projectile 219 once released may make contact with the target. In an embodiment, the drop device comprises a laser gun that releases one or more laser beams as the one or more projectiles. The laser gun may transmit one or more laser beams towards the target. The laser gun is initially maneuvered towards the one or more targets in the playing field. In an embodiment, the drop device may release one or more projectiles over the one or more targets.

The playfield with sensor array 206 is placed over the playing field. In an embodiment, the playing field comprises a static playing field. The user may need extraordinary skill to maneuver the drop device over the target and release the projectile towards the target. The array of sensors may comprise one of an array of infrared proximity sensors, an array of light detection and ranging (LIDAR) sensors, an array of mechanical switches, an array of tomographic sensors, an array of microwave motion sensors, an array of passive infrared (PIR) sensors, an array of ultrasonic sensors, etc. The playfield with sensor array 206 is adapted to determine contact location of the projectile on the playing field when the projectile is released by the drop device. The respective sensor on the array is bounded or limited to the respective target. For example, the LIDAR sensor continuously emits light and receives the reflected light from an object. When the projectile is released towards the target, the light emitted may coincide with the projectile and the receiver may experience a sudden change in the reflected light (e.g., time of flight, intensity of reflected light, timing of reflected light incidence, etc.) The computing unit is operable to set the output of the game as true when the projectile makes contact with the target in the playing field. In an embodiment, the computing unit is operable to set the output of the game as false, when the projectile 219 fails to make contact with the target in the playing field. In an embodiment, the computing unit is operable to assign a first point when the computing unit determines that the projectile 219 released is in contact with the target in the playing field. In another embodiment, the computing unit is operable to assign a second point when the computing unit determines that the projectile 219 released is towards a different target in the playing field. The computing unit then depicts, via the display, at least one of a point won by the user, one or more levels achieved, one or more rewards and a current status of the game.

In an embodiment, the playing field comprises an array of indicators. In an embodiment, a first indicator of the array of indicators located in a proximity range to a first sensor of the array of sensors, and a second indicator of the array of indicators located in the proximity range to a second sensor of the array of sensors. In another embodiment, the first indicator of the array of indicators communicatively coupled to the first sensor of the array of sensors, and the second indicator of the array of indicators communicatively coupled to the second sensor of the array of sensors. The first sensor communicates instructions to the first indicator to provide an indication upon detecting that the contact location of the one or more projectiles coincides with the one or more targets. The first sensor may communicate instructions upon determining that the one or more projectiles is towards the one or more targets. The first sensor may also communicate instructions upon determining that the one or more projectiles does not make contact with the target. The first indicator provides at least one of a sign, an alarm, an illumination, and a color, upon receiving the instructions from the first sensor.

Once the one or more projectiles are released, the one or more projectiles may contact the one or more targets. The one or more projectiles are collected at the bottom of the gaming unit. The projectile collection unit 210 collects the one or more projectiles released by the drop device. In an embodiment, the projectile collection unit 210 comprises a structure (e.g., funnel shaped structure, sloped structure, etc.) that covers the bottom of the playing field. The projectile collection unit 210 collects the one or more projectiles from the bottom of the playing field. The projectile conveyor unit 201 is coupled to the projectile collection unit 210. The projectile conveyor unit 201 picks up and transports the one or more projectiles from the projectile collection unit 210 to the drop device. The projectile conveyor unit 201 may pick up and transport the one or more projectiles in at least one of a vertical direction and a horizontal direction. The projectile conveyor unit 201 may comprise a conveyor belt that carries the one or more projectiles from one place to another place. The projectile conveyor unit 201 may be operated by a pneumatic unit which carries and transports the projectile using an air pressure. The projectile conveyor unit 201 may also be operated by a vacuum unit which carries and transports the projectile by means of sucking. The projectile conveyor unit 201 may also comprise a helical screw conveyor that collects, carries, and transports the one or more projectiles from projectile collection unit 210 to the drop device. The gaming unit further comprises a projectile loading unit that is coupled to the projectile conveyor unit 201. The projectile loading unit loads the one or more projectiles from the projectile conveyor unit 201 back to the drop device. The projectile loading unit comprises the flexible pipe with projectile buffer 202. The flexible pipe with projectile buffer 202 loads the one or more projectiles from the projectile conveyor unit 201 back to the drop device. The flexible pipe with projectile buffer 202 (e.g., flexible conduit) moves flexibly along with the device when the device is maneuvered. The flexible pipe with projectile buffer 202 (e.g., flexible conduit) loads the projectile from the conveyor unit to the device while the device is maneuvered to align with the one or more targets. In an embodiment, the drop device is operable to release seamlessly and simultaneously a plurality of projectiles among the one or more projectiles.

In an embodiment, the computing unit is operable to credit one or more playing chances to a user when the output of the game is set as true, wherein the playing chance enables the user to play the game. In another embodiment, the computing unit is operable to credit one or more playing chances to a user, when the one or more projectiles released are in contact (e.g., pass through the targets, hit the targets, revolve around the targets, follow the targets, virtually contact with the target (e.g., laser beam, light falling on the target), physically contact with the target etc.) the one or more predefined targets. In another embodiment, the computing unit is operable to credit the one or more playing chances to a user account by one of physically through a prepaid card and remotely through online. The computing unit is further operable to provide the one or more rewards to the user. The one or more rewards provide an extra play to the game via the gaming system.

In an embodiment, the gaming unit further comprises a control signal reception unit. The user may operate the gaming unit from a remote environment (e.g., remote place). The control signal reception unit receives at least one of a first virtual control signal and a second virtual control signal from a remote environment. The remote environment comprises one of an augmented reality environment, a virtual reality environment and a mixed reality environment. The remote environment generates a virtual model of the gaming system. In an embodiment, the virtual model comprises a virtual representation of the gaming system and a virtual user interface object at a respective location in the virtual representation of the gaming system. The virtual model comprises a virtual three-dimensional model. The virtual model receives an input through at least one of the virtual representation of the primary gaming unit and the virtual user interface object in the virtual representation. The virtual model communicates at least one of a first virtual control signal and a second virtual control signal to a control signal reception unit in response to the input.

In an embodiment, the computing unit is further configured to receive a fourth command to maneuver the drop device seamlessly and simultaneously in at least one of the first direction and the second direction and position the drop device over the target in response to the first virtual control signal; and receive a fifth command to release the projectile to make contact the target in the playing field in response to the second virtual control signal. The system enables the user to operate the gaming unit and get entertained from the remote place (which is useful during pandemics e.g., COVID). In an embodiment, the system may comprise a remote control. The user may operate the remote control (e.g., remote user interface) to interact with the gaming system and play the game from the remote place. In an embodiment, the remote environment comprises at least one of an augmented reality headset, an augmented reality glass, a virtual reality headset, a virtual reality glass and a remote control. The user may wear the virtual reality headset from a remote place and operate the gaming system as if the user was physically present in front of the gaming unit. The remote environment provides enhanced gaming experience to the user. In an embodiment, the gaming unit comprises a plurality of gaming cabinets synchronized with each other towards an objective. The system enables a plurality of users to play the game through the plurality of gaming cabinets. In an embodiment, the system enables a plurality of users to play the game through the plurality of gaming cabinets from the remote environment.

The gaming unit further comprises the monitor 205. The monitor 205 is adapted to depict scores won by the user. The gaming unit is further adapted to provide any hint or recommendations to the user while the user is playing the game via the monitor 205. The monitor 205 is integrated with the gaming unit. The gaming unit further comprises the card reader 209 and the ticket dispenser 211. The card reader 209 is configured to verify an identity of the user. The user may hold a card that holds the identity information of the user. The card reader 209 reads the card associated with the user and verifies the identity of the user. The card reader 209 is communicatively coupled to the ticket dispenser 211. The ticket dispenser 211 dispenses the ticket to the user. In an embodiment, the ticket dispenser 211 is communicatively coupled to the s playfield with sensor array 206. The playfield with sensor array 206 communicates a signal to the ticket dispenser 211 upon determining that the projectile has made contact with the target. The ticket dispenser 211 upon receiving the signal from the playfield with sensor array 206 may dispense tickets to the user.

FIG. 3 illustrates the mobility of a drop device of a gaming unit, according to one or more embodiments. The drop device may be supported by a gantry. The gantry may be a movable gantry. The drop device may be a crane. The drop device can be adapted to move in at least one of a first direction, a second direction, and a third direction. The drop device is operated by a user via a joystick. The first direction is perpendicular to a second direction in the same plane (e.g., horizontal plane). In an embodiment, the first direction represents x-axis, and the second direction represents y-axis. The drop device can also move in the z-axis (height wise). In another embodiment, the first direction in a first plane (e.g., horizontal plane) is perpendicular to the second direction in a second plane (e.g., vertical plane). The drop device may also operate in both horizontal direction and vertical direction seamlessly and simultaneously. The gantry may have a gear mechanism having a first gear and a second gear coupled to a driving motor. The first gear is adapted to operate the drop device in x direction. The second gear is adapted to operate the drop device in y direction. The gaming unit enables the user to activate a locking mechanism that locks the first gear and the second gear. The user when operating the input device operates the motor that drives the first gear and the second gear simultaneously which in turn operates the drop device in both horizontal direction and vertical direction seamlessly and simultaneously. The locking mechanism may also have a third gear that is adapted to adjust the lower or increase the height of the drop device.

The user may operate the joystick to maneuver the drop device. The controller receives inputs from the joystick and operates the drop device in accordance with the joystick operation. The controller is adapted to maneuver the drop device seamlessly and simultaneously in at least one of the first direction and the second direction and position the drop device over a target. The button is adapted to release the projectile upon positioning the drop device over a target. The user may need to utilize his/her skill to maneuver the drop device and release the projectile to make contact with the target.

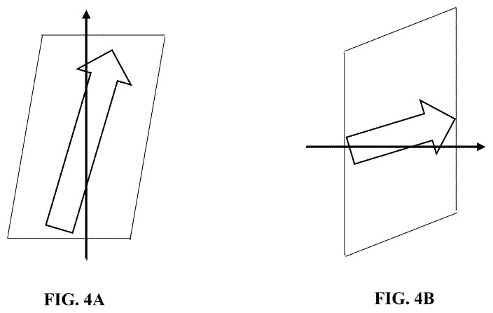

FIG. 4A and FIG. 4B illustrate the mobility of a drop device in the same plane, according to one or more embodiments. The drop device is capable of moving in a first direction and a second direction in the same plane (e.g., horizontal plane or vertical plane). According to this embodiment, the drop device moves in the same plane (either horizontal plane or vertical plane). FIG. 4A shows the mobility of the drop device in the first direction and second direction of the horizontal plane whereas FIG. 4B shows the mobility of the drop device in the first direction and second direction of the vertical plane.

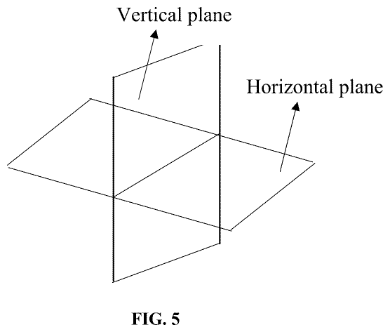

FIG. 5 illustrates the mobility of a drop device in two different planes, according to one or more embodiments. The drop device is capable of moving in a first direction in a first plane (e.g., horizontal plane) and a second direction in a second plane (e.g., vertical plane). According to this embodiment, the drop device moves seamlessly in two different planes (horizontal plane and vertical plane). In the horizontal plane, the drop device moves in the lateral direction. In the vertical plane, the drop device moves vertically (height wise).

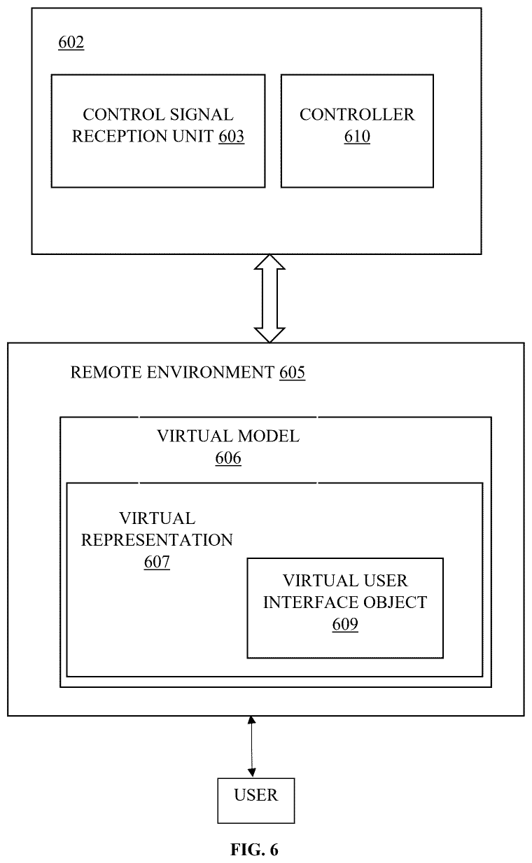

FIG. 6 illustrates a block diagram of a gaming system 602 operated from a virtual reality environment, according to one or more embodiments. The gaming system 602 comprises a control signal reception unit 603. The control signal reception unit 603 receives at least one of a first virtual control signal and a second virtual control signal from a remote environment 605. The remote environment 605 comprises one of an augmented reality environment, a virtual reality environment and a mixed reality environment. The remote environment 605 generates a virtual model 606 of the gaming system 602. In an embodiment, the virtual model 606 comprises a virtual three-dimensional model. The virtual model 606 comprises a virtual representation 607 of the gaming system 602 and a virtual user interface object 609 at a respective location in the virtual representation 607 of the primary gaming unit.

The virtual model 606 receives an input through at least one of the virtual representation 607 of the gaming system 602 and the virtual user interface object 609 in the virtual representation 607. For example, the user in the remote environment 605 approaches the virtual representation 607 of the gaming system 602 and interacts through the virtual representation 607 and/or the virtual user interface object 609. The user may operate the virtual user interface object 609 (e.g., virtual joystick, virtual button, virtual touch screen, virtual input device etc.) in the remote environment 605. The remote environment 605 also provides projections (e.g., illuminations) within the virtual model 606. The virtual model 606 reacts and provides interactive reality augmentation through illuminations in response to the input provided by the user. The interactive reality augmentation provides an immersive experience to the user. Immersive experiences use a blend of visuals, sound, and technology to deliver unforgettable and engaging worlds. The virtual model receives the input from the user and communicates at least one of the first virtual control signal and the second virtual control signal to the control signal reception unit in response to the input.

The control signal reception unit 603 of the gaming system 602 receives the first virtual control signal and the second virtual control signal. The control signal reception unit 603 then communicates instructions to the controller 610 in response to the virtual control signals. The controller 610 is configured to maneuver the drop device seamlessly and simultaneously in at least one of the first direction and the second direction and position the drop device over the target in response to the first virtual control signal. The controller 610 is also configured to release the projectile to contact the target in the playing field in response to the second virtual control signal. The controller 610 comprises a computing unit. In one embodiment, the computing unit, and the controller 610 are integrated into a single unit.

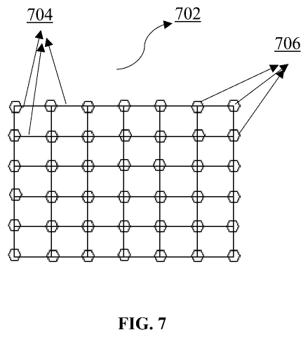

FIG. 7 illustrates the mobility of a drop device, according to one or more embodiments. The gaming unit comprises a guiding mechanism 702 that comprises one or more nodes connected via one or more paths. The guiding mechanism 702 provides enhanced mobility to the drop device. The one or more nodes 706 may refer to the positions/locations that are aligned with the one or more targets in the playing field. The guiding mechanism may be at the top whereas the playing field is at the bottom. The drop device may travel from one node to another node via the one or more paths 704. The drop device may be operated by the user using an input device.

The guiding mechanism guides the drop device to travel in a predefined location through the one or more paths and aligns the drop device towards one or more predefined targets. The one or more paths 704 in the guiding mechanism are one or more restricted paths that guide only to the one or more nodes 706 that are aligned to one or more targets in the playing field, respectively.

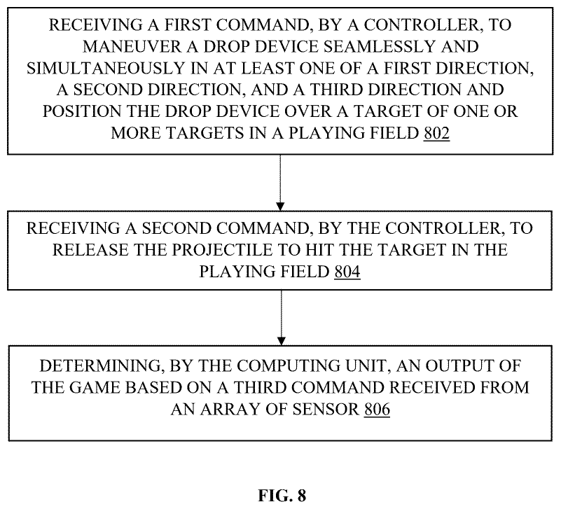

FIG. 8 illustrates a method of executing a game by a gaming system, according to one or more embodiments. At step 802, receiving, a first command, by a controller, to maneuver a drop device seamlessly and simultaneously in at least one of a first direction, a second direction, and a third direction and position the drop device over one or more targets in a playing field. At step 804, receiving a second command, by the controller, to release the projectile towards the target in the playing field. At step 806, determining, by a computing unit, an output of the game based on a third command received from an array of sensors. In an embodiment, the drop device is configured to dynamically move and align with respect to each target of the one or more targets in the playing field upon receiving the first command. In another embodiment, the playing field comprises the one or more targets.

In an embodiment, the co-ordinates of the one or more targets in the playing field are pre-stored within the memory of the gaming system. The playing field is static in nature. The co-ordinates of the one or more targets in the static playing field may be constant. The co-ordinates of the one or more targets in the dynamic playing field may change. The artificial intelligence engine is configured to relate the co-ordinates of the one or more targets with respect to at least one of an alignment, a position, or a location of the dynamic playing field to determine the real-world co-ordinates of the targets. The real-world co-ordinates are used to match the co-ordinates of the contact location of the projectile with the location of the one or more targets and to determine whether the projectile has achieved the target.

In one embodiment, the computing unit determines the output of the game using the artificial intelligence engine. The artificial intelligence engine is configured to retrieve the co-ordinates of the one or more targets in the playing field from the memory. The artificial intelligence engine then monitors the co-ordinates of the contact location of the one or more projectiles. The artificial intelligence engine then matches the co-ordinates of the targets in the playing field and the co-ordinates of the contact location of the projectile to determine whether the one or more projectiles has made contact with the one or more targets.

The computing unit, using an artificial intelligence engine, credits a point to the user upon determining that the user has won the game (i.e., the projectile makes contact with the target). In an embodiment, the computing unit, using the artificial intelligence engine provides an additional chance to play the game upon determining that the user has won the game. In another embodiment, the computing unit, using an artificial intelligence engine, provides at least one of a gift, a reward, a token, and a ticket to the user based on the output of the game.

In one aspect, a non-transitory computer storage medium is described. The non-transitory computer storage medium storing a sequence of instructions, which when executed by a processor, causes: receiving a first command to maneuver a drop device seamlessly and simultaneously in at least one of a first direction, a second direction, and a third direction and position the drop device over one or more targets in a playing field; receiving a second command to release the one or more projectiles towards the target in the playing field; and determining an output of the game based on a third command received from an array of sensors. The drop device is configured to dynamically move and align with respect to each target of the one or more targets in the playing field upon receiving the first command. The playing field comprises the one or more targets.

In an embodiment of the system, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a precious step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

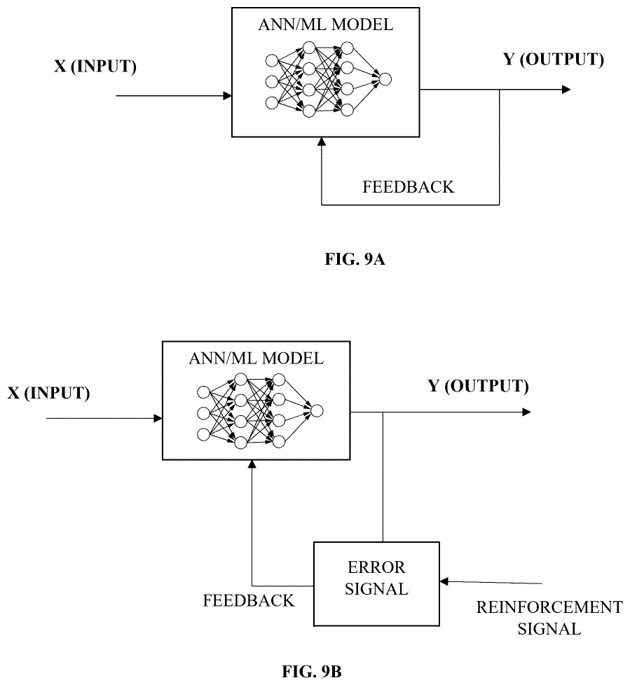

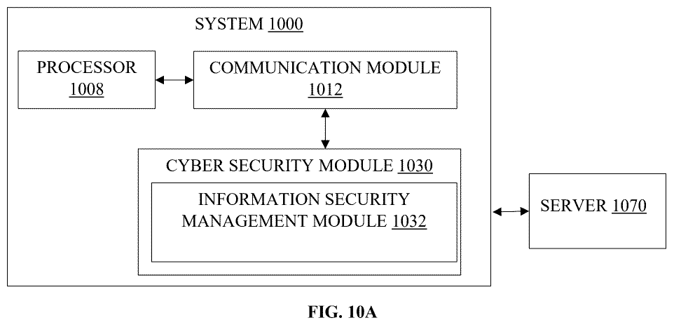

FIG. 9A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict or detect an appropriate location to which the drop device is to be maneuvered, and the projectile is released based on the input data (e.g., user behavior, previous plays of the user, procedure for playing the game, etc.).

In an embodiment, ANN's may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models'performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., appropriate locations to which the drop device is to be maneuvered and the projectile to be released) are used that are meant for the model to learn. Afterward, the model is tested using unlabelled data. By using, for example, deep learning and neural networks, the model can then make predictions on whether the desired concept/s (for e.g., appropriate locations to which the drop device is to be maneuvered and the projectile to be released are in unlabelled images. Each image is given a probability score where higher scores represent a higher level of confidence in the models'predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 9B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor 1008 in communication with memory. The processor 1008 is programmed to receive, from a first device, a first data message. The first data message is in a standardized data format. The processor 1008 is also programmed to analyze the first data message for potential cyber security threats. If the determination is that the first data message does not contain a cyber security threat, the processor 1008 is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

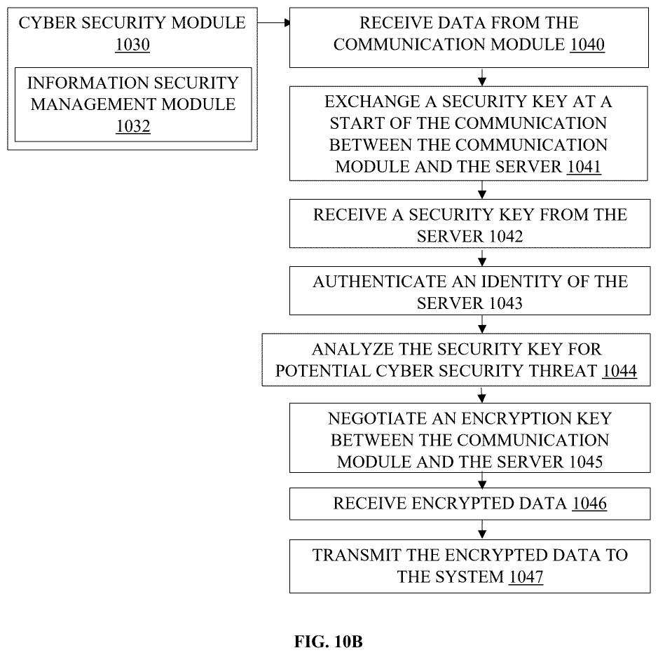

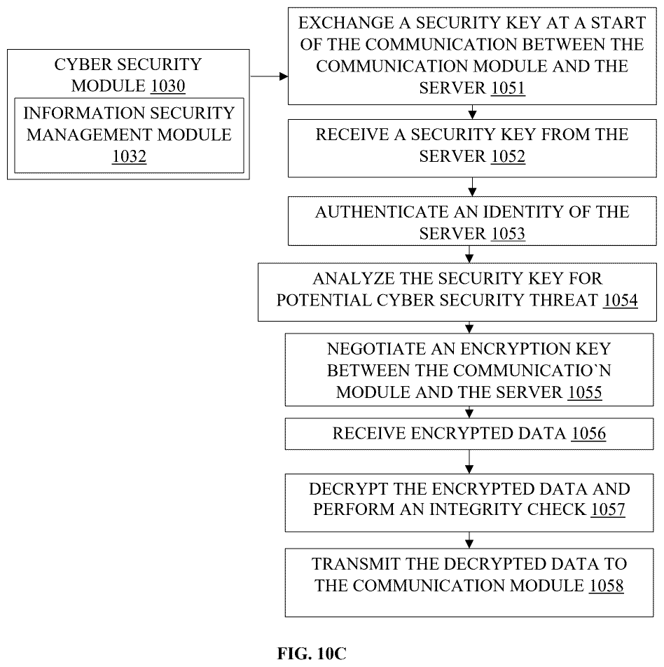

In an embodiment, FIG. 10A shows the block diagram of the cyber security module. The communication of data between the system 1000 and the server 1070 through the communication module 1012 is first verified by the information security management module 1032 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 10B shows the flowchart of securing the data through the cyber security module 1030. At step 1040, the information security management module is operable to receive data from the communication module. At step 1041, the information security management module exchanges a security key at a start of the communication between the communication module and the server. At step 1042, the information security management module receives a security key from the server. At step 1043, the information security management module authenticates an identity of the server by verifying the security key. At step 1044, the information security management module analyzes the security key for potential cyber security threats. At step 1045, the information security management module negotiates an encryption key between the communication module and the server. At step 1046, the information security management module receives the encrypted data. At step 1047, the information security management module transmits the encrypted data to the server when no cyber security threat is detected.

In an embodiment, FIG. 10C shows the flowchart of securing the data through the cyber security module 1030. At step 1051, the information security management module is operable to: exchange a security key at a start of the communication between the communication module and the server. At step 1052, the information security management module receives a security key from the server. At step 1053, the information security management module authenticates an identity of the server by verifying the security key. At step 1054, the information security management module analyzes the security key for potential cyber security threats. At step 1055, the information security management module negotiates an encryption key between the communication module and the server. At step 1056, the information security management module receives encrypted data. At step 1057, the information security management module decrypts the encrypted data, and performs an integrity check of the decrypted data. At step 1058, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 10A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

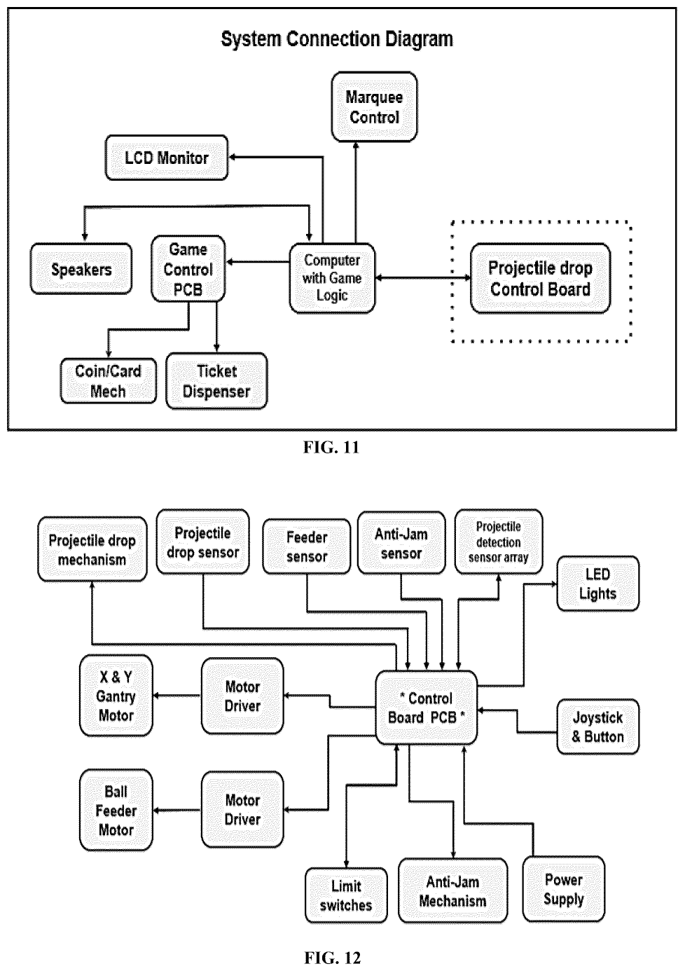

FIG. 11 illustrates a block diagram of a system according to one or more embodiments. The system comprises a computing unit, a projectile drop control board, and a game control board. The computing unit comprises a game logic. The game logic refers to a programming logic applied to a game. The game logic may refer to an internal mechanism of a game in order to perform all the tasks needed for execution of the game. The computing unit communicates with a marquee control component to control and maneuver the drop device. The marquee control is operable to seamlessly maneuver the drop device in response to the user input received via the input device. In an embodiment, the computing unit is integrated with a controller (i.e., the projectile drop game control board).

The computing unit further comprises a monitor (e.g., liquid crystal display (LCD) monitor) to depict at least one of at least one of points won by the user, one or more levels achieved, one or more rewards and a current status of the game. The computing unit further comprises speakers to provide an audio output of the user. The audio output may be audio regarding at least one of points won by the user, one or more levels achieved, one or more rewards and a current status of the game. The game control board receives instructions from the computing unit having the game logic. The game control board communicates instructions to coin/card operator and a ticket dispenser. The computing unit determines the output of the game and communicates instructions to the game control board to dispense rewards. The game control board then operates a coin/card operated machine and a ticket dispenser. The coin/card machine dispenses coins and/or cards to reward the user upon receiving instructions from the computing unit. The one or more rewards may provide an extra play to the game via the gaming unit. The ticket dispenser may dispense the tickets to reward the user upon receiving instructions from the computing unit.

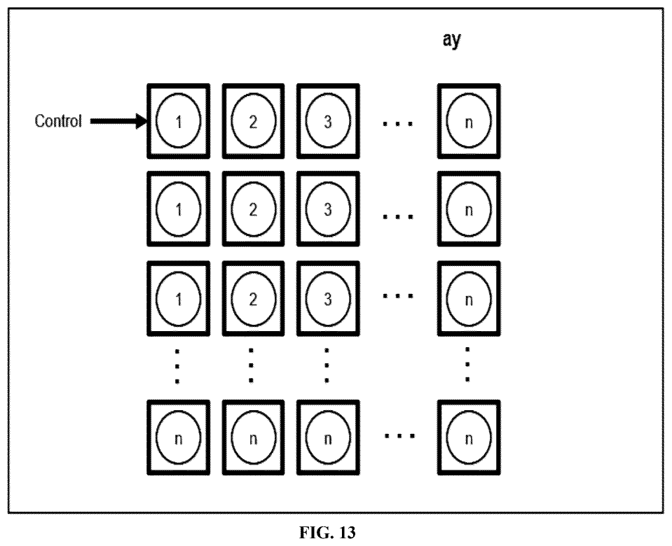

FIG. 12 illustrates a block diagram of a gaming unit, according to one or more embodiments. The gaming unit comprises a controller (e.g., control board PCB as shown in FIG. 12). The controller receives power input from a power supply. The controller receives input from the user via the input devices (e.g., joystick and button). The controller upon receiving the inputs communicates instructions to the projectile dropping mechanism (i.e., game logic residing within the computing unit). The projectile dropping mechanism (i.e., game logic residing within the computing unit) executes the game in response to the user inputs.

The controller upon receiving the inputs activates the motor drivers to turn on the projectile feeder motor (e.g., ball feeder motor) and X and Y gantry motor, which in turn maneuvers the drop device aligned over the one or more targets and releases the one or more projectiles towards the one or more targets.

The controller parallelly receives feedback signal from the projectile drop sensor, feeder sensor, anti-jam sensor, and projectile detection sensor array. The projectile drop sensor may be associated with the drop device to determine the drop or release of the projectile. The projectile drop sensor may be one of an electronic sensor, a mechanical sensor, a mechanical switch, etc. The feeder sensor may be associated with the projectile conveyor unit and/or the flexible conduit that determines whether the one or more projectiles are fed to the drop device. The feeder sensor may also determine the count of the number of projectiles fed to the drop device. The anti-jam sensor is adapted to determine whether the gaming unit is stuck (i.e., jammed). The anti-jam sensor may determine whether the one or more projectiles are fed to the drop device within a predefined period of time. For example, the anti-jam sensor may comprise a mechanical switch positioned within the drop device, or projectile conveyor unit or the drop device. The mechanical switch gets turned on when the projectile contacts with the mechanical switch, which indicates that the gaming unit is working and not in a jammed state. For another example, the anti-jam sensor may comprise a mechanical switch positioned within the targets. The mechanical switch gets turned on when the projectile contacts with the mechanical switch upon passing towards the target, which indicates that the gaming unit is working and not in a jammed state. The projectile detection sensor array comprises one of an array of infrared proximity sensors, an array of light detection and ranging (LIDAR) sensors, an array of mechanical switches, an array of tomographic sensors, an array of microwave motion sensors, an array of passive infrared (PIR) sensors, an array of ultrasonic sensors, etc. The projectile detection sensor array determines the contact location of the projectile and communicates to the computing unit. The computing unit determines the output of the game based on the information received from the sensors (e.g., projectile drop sensor, feeder sensor, anti-jam sensor, and projectile detection sensor array).

The computing unit also instructs the anti-jamming mechanism to reboot the gaming unit if and when the gaming unit is in a jammed state. In one embodiment, the computing unit determines that the gaming unit is in a jammed state through the use of the one or more limit switches incorporated at different places within the gaming unit. The limits switches indicate that the gaming unit is operating well (i.e., without any jamming) up to the point where the limit switch is positioned. The gaming unit may comprise one or more limit switches at different portions to determine whether the particular portion or section of the gaming unit is jammed or stuck. Each limit switch is associated with different sections to ensure the proper functioning of different sections. The gaming unit may comprise a reset unit which when activated reboots/resets the gaming unit by actuating all the electronic and mechanical components to ensure anti-jamming.

FIG. 13 illustrates an array of sensors, according to one or more embodiments. The array of sensors comprises a plurality of sensors arranged in rows and columns fashion throughout the space of the playing field occupied by the one or more targets. In an embodiment, the array of sensors may comprise a plurality of sensors arranged in random fashion. In another embodiment, the array of sensors may be located in proximity to the one or more targets to determine whether the one or more projectiles are towards the one or more targets.

The array of sensors is communicatively coupled to the computing unit. The array of sensors communicates information regarding whether the one or more projectiles has achieved the one or more targets to the computing unit. The computing unit assigns a point to the game based on the information received from the array of sensors. The array of sensors comprises one of an array of infrared proximity sensors, an array of light detection and ranging (LIDAR) sensors, an array of mechanical switches, an array of tomographic sensors, an array of microwave motion sensors, an array of passive infrared (PIR) sensors, an array of capacitive sensors, an array of line cut sensors, and an array of ultrasonic sensors.

The array of sensors may also determine that the one or more projectiles are released from the drop device and trigger a signal to the projectile collection unit to collect the one or more projectiles. The array of sensors may also determine the count of the one or more projectiles released and collected. The computing unit, upon receiving information from the array of sensors, communicates to a display to depict at least one of points won by the user, one or more levels achieved, one or more rewards and a current status of the game.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a non-transitory machine-readable medium and/or self-contained projectile dropping game. Accordingly, the specification and drawings are to be regarded in an illustrative rather than a restrictive sense.

### INCORPORATION BY REFERENCE

All publications, patents, and patent applications cited in this Specification are hereby incorporated by reference in their entirety, including:
CN201510792106 entitled “Movable gantry type micro array sensor preparing device”;
EP3891459A1 entitled “Projectile lift”;
U.S. Pat. No. 6,135,387A entitled “Method for autonomous guidance of a spin-stabilized artillery projectile and autonomously guided artillery projectile for realizing this method”;
U.S. Pat. No. 11,346,624B2 entitled “Projectile loading system for toy launcher and methods”;
KR102218596B1 entitled “Portable lift for crane”;
U.S. Pat. No. 9,586,138B2 entitled “Apparatus, systems, and methods for detecting projectile hits on a surface”;
U.S. Pat. No. 8,476,896B2 entitled “Method and sensor arrangement for determining the position and/or change of position of a measured object relative to a sensor”;
U.S. Pat. No. 7,951,008B2 entitled “Non-volatile memory management technique implemented in a gaming machine”;
U.S. Pat. No. 8,632,406B2 entitled “Player tracking communication mechanisms in a gaming machine”;
U.S. Pat. No. 6,007,426A entitled “Skill based prize games for wide area networks”;
U.S. Pat. No. 8,506,373B2 entitled “Amusement device prize awarding system and method”;
U.S. Pat. No. 8,721,431B2 entitled “Systems, methods, and devices for providing instances of a secondary game”;
JP2014111197A entitled “Crane game machine”;
JP10263195 entitled “Game ball counter with lift”;
U.S. Pat. No. 8,678,395B2 entitled “Ball drop game”;
U.S. Pat. No. 11,288,930B1 entitled “Game method using ticket output game machine”; and
U.S. Pat. No. 7,507,152B2 entitled “Ball drop amusement game”.

1-122. (canceled)

123. A system comprising:
a gaming unit that provides a game to a user;
wherein the gaming unit comprises:
a drop device that holds one or more projectiles;
a computing unit comprising a game logic;
a controller electronically coupled to the computing unit, the controller operable to
receive a first command to maneuver the drop device seamlessly and simultaneously in at least one of a first direction, a second direction, and a third direction and position the drop device over one or more targets in a playing field; and
receive a second command to release the one or more projectiles towards the one or more targets in the playing field; and
an array of sensors that determines a contact location of the one or more projectiles on the playing field;
wherein the computing unit is further operable to determine an output of the game based on a third command received from the array of sensors;
wherein the drop device is configured to dynamically move and align with respect to each target of the one or more targets in the playing field upon receiving the first command; and
wherein the playing field comprises the one or more targets.

124. The system of claim 123, wherein the computing unit comprises an artificial intelligence engine.

125. The system of claim 124, wherein the computing unit monitors the output of the game and assigns a point based on the output of the game.

126. The system of claim 125, wherein the computing unit determines whether the one or more projectiles repeatedly and consistently is released towards at least one of a plurality of first targets, a plurality of second targets, and a plurality of third targets.

127. The system of claim 126, wherein the computing unit is operable to assign a first point when the controller determines whether the one or more projectiles is repeatedly released towards at least one of the plurality of first targets, the plurality of second targets, and the plurality of third targets.

128. The system of claim 123, wherein the first direction is perpendicular to the second direction in a plane.

129. The system of claim 123, wherein the first direction in a first plane is perpendicular to the second direction in a second plane.

130. The system of claim 123, wherein the gaming unit providing the game further comprises:
a projectile collection unit that comprises a structure that covers a bottom of the playing field and collects the one or more projectiles from the bottom of the playing field;
a projectile conveyor unit that picks up and transports the one or more projectiles from the projectile collection unit to the drop device; and
a projectile loading unit that loads the one or more projectiles from the projectile conveyor unit to the drop device.

131. The system of claim 125, wherein the artificial intelligence engine is configured to:
analyze a behavior of the user based on one or more user inputs;
analyze a previous execution of the game in response to the one or more user inputs; and
generate at least one of a suggestion, a recommendation, and a hint based on at least one of the analysis of the behavior of the user and the analysis of the previous execution of the game.

132. The system of claim 131, wherein the artificial intelligence engine analyzes the behavior of the user by analyzing a pattern of the one or more user inputs.

133. The system of claim 123, wherein the gaming unit further comprises:
a control signal reception unit that receives at least one of a first virtual control signal and a second virtual control signal from a remote environment.

134. The system of claim 133, wherein the system generates a virtual model of the gaming unit.

135. The system of claim 134, wherein the virtual model receives an input through at least one of a virtual representation of the gaming unit and a virtual user interface object in the virtual representation and communicates at least one of the first virtual control signal and the second virtual control signal to the control signal reception unit in response to the input.

136. The system of claim 135, wherein the controller is further configured to:
receive a fourth command to maneuver the drop device seamlessly and simultaneously in at least one of the first direction, the second direction, and the third direction and position the drop device over the one or more targets in response to the first virtual control signal; and
receive a fifth command to release the one or more projectiles towards the one or more targets in the playing field in response to the second virtual control signal.

137. A method comprising:
receiving a first command, by a controller, to maneuver a drop device seamlessly and simultaneously in at least one of a first direction, a second direction, and a third direction and position the drop device over one or more targets in a playing field;
receiving a second command, by the controller, to release one or more projectiles towards the one or more targets in the playing field; and
determining, by a computing unit, an output of a game based on a third command received from an array of sensors;
wherein the drop device is configured to dynamically move and align with respect to each target of the one or more targets in the playing field upon receiving the first command; and
wherein the playing field comprises the one or more targets.

138. The method of claim 137, wherein the method further comprises: determining whether the one or more projectiles makes contact with one or more predefined targets among the one or more targets.

139. The method of claim 137, wherein the method further comprises: crediting one or more playing chances to a user when the one or more projectiles contacts the one or more targets in the playing field, wherein the one or more playing chances enables the user to play the game.

140. A non-transitory computer readable storage medium storing a sequence of instructions, which when executed by a processor, causes:
receiving a first command to maneuver a drop device seamlessly and simultaneously in at least one of a first direction, a second direction, and a third direction and position the drop device over one or more targets in a playing field;
receiving a second command to release one or more projectiles towards the one or more targets in the playing field; and
determining an output of a game based on a third command received from an array of sensors;
wherein the drop device is configured to dynamically move and align with respect to each target of the one or more targets in the playing field upon receiving the first command; and
wherein the playing field comprises the one or more targets.

141. The non-transitory computer readable storage medium of claim 140, further causes:
depicting, via a display, at least one of points won by a user, one or more levels achieved, one or more rewards and a current status of the game.

142. The non-transitory computer readable storage medium of claim 140, further causes:
crediting one or more playing chances to a user when the one or more projectiles contacts the one or more targets in the playing field, wherein the one or more playing chances enables the user to play the game.
